(19) United States
(12) Patent Application Publication
(10) Pub. No.: US 2015/0287058 A1
(43) Pub. Date: Oct. 8, 2015

(54) SYSTEM AND METHOD FOR RECOMMENDING PRICES FOR PARKING USING BLOCKING RATES AND TRAFFIC FLUX

(71) Applicant: Xerox Corporation, Norwalk, CT (US)

(72) Inventors: Christopher R. Dance, Grenoble (FR); Onno R. Zoeter, Grenoble (FR)

(73) Assignee: Xerox Corporation, Norwalk, CT (US)

(21) Appl. No.: 14/247,443

(22) Filed: Apr. 8, 2014

(51) Int. Cl. G06Q 30/02

(52) U.S. Cl. CPC G06Q 30/0202

(57) ABSTRACT

A system and method for recommending pricing using blocking rates and traffic flux. For a given block face, occupancy and traffic flow information are collected and analyzed to determine a blocking rate. The traffic flux for the block face is determined using the collected traffic flow information. External costs, including cost to drivers slowed and cost to drivers blocked from parking are estimated and a cost rate is determined as a function of the blocking rate, the traffic flux, and the external costs. A utility rate is calculated and a price change is recommended based upon a maximization of the utility rate.

### BACKGROUND

The subject disclosure is directed to the traffic monitoring arts, the parking arts, the pricing arts, the traffic control arts, and the like.

Large cities generally offer substantial on-street parking, with prices varying in accordance with the location which is frequently divided by block face (the portion of one side of a street that lies between two blocks) the time of day and sometimes with the recent occupancy level (the number of vehicles parked on the block face at any given time during two preceding six-month time periods). Parking sensors may be implemented on block faces to track this occupancy, with the occupancy then being used to either raise or lower the price for parking on the associated block face. The modification of pricing for parking spaces is based generally on the supposition that pricing should be set so that there will be a space for a driver willing to pay the fee. Based on this supposition, the price for parking may increase as the number of spaces available decreases, or decrease as the number of spaces increases. See, e.g., Vickrey, W. S. 1954, “The Economizing of Curb Parking Space,” Traffic Engineering Magazine, Nov. Reprinted in Journal of Urban Economics 36, (1994), 56-65, the entirety of which is incorporated by reference herein.

Various municipalities have implemented variations of this pricing determination, including the basing prices on the occupancy fraction (the time average of the fraction of spaces that are full). That is, if the occupancy fraction is higher or lower than a threshold, the prices will correspondingly be increased or decreased. Thus, this scheme attempts to keep prices as low as possible without having too high a fraction of occupied spaces. The scheme controls the fraction of occupied spaces by setting prices to maximize the number of occupied spaces while limiting the maximum average number of occupied spaces.

Another variation is the fraction-of-time-full (the fraction of time that availability is zero or near to zero) pricing scheme. The fraction-of-time-full does slightly improve over the occupancy fraction pricing scheme, as it is capable of distinguishing between a 70% occupancy fraction as a “good thing”, where for instance the fraction of full spaces varies uniformly between 50% and 90%; and a 70% occupancy as “bad thing”, where 40% of the spaces are full half of the time and 100% of the spaces are full the other half of the time. That is, the occupancy fraction approach masks important observations that suggest that prices should be increased or decreased. This scheme attempts to maintain as low as possible prices without having too large a fraction of time with near-to-zero availability. The scheme manages this by controlling the fraction of time that the street is fully occupied. Thus, prices are set so as to maximize the number of occupied spaces while limiting the fraction of time that there are no available spaces.

However, each of the past approaches to pricing determination based upon the aforementioned suppositions of Vickrey that are currently in use also inherently include several shortcomings. For example, the pricing schemes ignore how many people (i.e. vehicles) are arriving, e.g., the arrival rate. If availability is zero at a busy time of the day, then many vehicles may be arriving but are blocked from parking, causing high externality costs. On the other hand, if availability is zero in the middle of the night, then perhaps only a very few people are arriving and are blocked from parking, thereby resulting in low externality costs. In some cities, e.g., Los Angeles, the arrival rate varies more than a factor of ten over different streets and different times of the week, thus this shortcoming may be rather important in pricing.

Another shortcoming is that neither extension of the supposition factors into account that congestion impacts the externality costs associated with parking pricing. That is, the schemes referenced above do not take into account how much congestion is being caused by low (and not necessarily zero) availability, e.g., drivers slowing down looking for a space, maneuvering into a space, turning around, etc. For example, neither scheme factors in the traffic flux, i.e., the number of vehicles passing through the street per some unit of time in the same direction as the driver who was blocked.

A further shortcoming may include the costs associated with the distance from a desired space a driver is forced to park. That is, the schemes referenced above do not factor any costs incurred by a driver that wanted to park at a given location, was blocked, and subsequently forced to park at a space a distance away, e.g., the cost in fuel, walking time, etc.

Thus it would be advantageous to provide a method and system to assist in evaluating and recommending pricing that incorporates the arrival rate, the congestion, and/or the distance.

### INCORPORATION BY REFERENCE

The following references, the disclosures of which are incorporated herein by reference in their entirety, are mentioned:

U.S. Pat. No. 4,971,505, issued Nov. 20, 1990, entitled ARCHITECTURAL STRUCTURE FOR OCCUPANCY AND PARKING, by Sawyer; U.S. Pat. No. 5,432,508, issued Jul. 11, 1995, entitled TECHNIQUE FOR FACILITATING AND MONITORING VEHICLE PARKING, by Jackson; U.S. Pat. No. 6,285,297, issued Sep. 4, 2001, entitled DETERMINING THE AVAILABILITY OF PARKING SPACES, by Ball; U.S. Pat. No. 6,344,806, issued Feb. 5, 2002, entitled PARKING STATUS CONTROL SYSTEM AND METHOD, by Katz; U.S. Pat. No. 6,671,737, issued Dec. 30, 2003, entitled DECENTRALIZED NETWORK SYSTEM, by Snowdon et al.; U.S. Pat. No. 7,116,246, issued Oct. 3, 2006, entitled APPARATUS AND METHOD FOR SENSING THE OCCUPANCY STATUS OF PARKING SPACES IN A PARKING LOT, by Winter et al.; U.S. Pat. No. 7,492,283, issued Feb. 17, 2009, entitled SYSTEMS AND METHODS FOR COMMUNICATION OF PARKING INFORMATION, by Racunas, Jr.; U.S. Pat. No. 7,647,185, issued Jan. 12, 2010, entitled APPARATUS AND METHOD FOR SENSING THE OCCUPANCY STATUS OF PARKING SPACES IN A PARKING LOT, by Tarassenko et al.; U.S. Pat. No. 7,889,099, issued Feb. 15, 2011, entitled PARKING-ZONE MANAGEMENT SYSTEM, by Aubrey et al.; U.S. Publication No. 2013/0262059, published Oct. 3, 2013, entitled MODEL FOR USE OF DATA STREAMS OF OCCUPANCY THAT ARE SUSCEPTIBLE TO MISSING DATA, by Grbovic et al.; U.S. Publication No. 2013/0265419, published Oct. 10, 2013, entitled SYSTEM AND METHOD FOR AVAILABLE PARKING SPACE ESTIMATION FOR MULTISPACE ON-STREET PARKING, by Bulan et al.; U.S. Publication No. 2013/0265423, published Oct. 10, 2013, entitled VIDEO-BASED DETECTOR AND NOTIFIER FOR SHORT-TERM PARKING VIOLATION ENFORCEMENT, by Bernal et al.; U.S. Publication No. 2013/0266185, published Oct. 10, 2013, entitled VIDEO-BASED SYSTEM AND METHOD FOR DETECTING EXCLUSION ZONE INFRACTIONS, by Bulan et al.; U.S. Publication No. 2013/0266190, published Oct. 10, 2013, entitled SYSTEM AND METHOD FOR STREET-PARKING-VEHICLE IDENTIFICATION THROUGH LICENSE PLATE CAPTURING, by Wang et al.; U.S. application Ser. No. 13/684,817, filed Nov. 26, 2012, entitled SYSTEM AND METHOD FOR ESTIMATION OF AVAILABLE PARKING SPACE THROUGH INTERSECTION TRAFFIC COUNTING, by Rong et al.; U.S. application Ser. No. 13/835,386, filed Mar. 15, 2013, entitled TWO-DIMENSIONAL AND THREE-DIMENSIONAL SLIDING WINDOW-BASED METHODS AND SYSTEMS FOR DETECTING VEHICLES, by Bulan et al.; U.S. application Ser. No. 13/836,310, filed Mar. 15, 2013, entitled METHODS AND SYSTEMS FOR AUTOMATED IN-FIELD HIERARCHICAL TRAINING OF A VEHICLE DETECTION SYSTEM, by Wu et al.; U.S. application Ser. No. 13/861,553, filed Apr. 12, 2013, entitled A WIRELESS PARKING REGISTER/PAYMENT AND VIOLATION NOTIFICATION METHOD AND SYSTEM, by Bulan et al.; U.S. application Ser. No. 13/898,883, filed May 21, 2013, entitled ROUTE COMPUTATION FOR NAVIGATION SYSTEM USING DATA EXCHANGED WITH TICKET VENDING MACHINES, by Proux; and U.S. patent application Ser. No. 13/969,762, filed Aug. 19, 2013, entitled SIMPLE PRICING BY PRICE-DIFFERENCE REGULARIZATION, by Dance et al., and Vickrey, W. S. 1954, “The Economizing of Curb Parking Space,” Traffic Engineering Magazine, Nov. Reprinted in Journal of Urban Economics 36, (1994), 56-65.

### BRIEF DESCRIPTION

In accordance with one aspect of the exemplary embodiment, a method for recommending prices for parking includes receiving data representative of parking occupancy for an associated block face during an analysis period, and receiving data representative of traffic flow for the associated block face during the analysis period. The method further includes estimating a blocking rate for the analysis period in accordance with the received parking occupancy data and the traffic flow data. In addition, the method includes determining a recommended price for parking on the associated block face during the analysis period in accordance with the estimated blocking rate and traffic flow data. At least one of the receiving, receiving, estimating, or determining is performed by a processor in communication with associated memory.

According to another aspect, a system for recommending prices for parking includes a processor, and a blocking rate estimation unit configured for computing a blocking rate in accordance with occupancy data and traffic flow information corresponding to an associated block face during an analysis period. The system further includes a traffic flux determination unit configured for computing a traffic flux for the block face during the analysis period, and an externality cost determination unit configured for computing at least one externality cost associated with parking on the associated block face. The system also includes a cost rate estimation unit configured for computing a cost rate for the block face during the analysis period in accordance with the blocking rate, the traffic flux, and the at least one externality cost, and memory in communication with the processor. The memory stores instructions which are executed by the processor for determining a valuation rate for each occupied space on the associated block face during a portion of a time interval of the analysis period. The instructions are also for calculating an average valuation rate for parking during the portion of the time interval on the associated block face via the determined valuation rates, and calculating a utility rate for each portion of the time interval of the analysis period, the utility rate corresponding to a difference between the average valuation rate and the cost rate for the portion of the time interval. In addition, the instructions are for maximizing the utility rate for the portion of the time interval to determine a recommended price corresponding thereto.

In another aspect, a computer-implemented method for recommending prices for parking includes receiving occupancy data corresponding to a block face of interest, and receiving traffic flow information associated with the block face of interest. The method also includes estimating a blocking rate for the block face of interest in accordance with the occupancy data and the traffic flow information during an analysis period. In addition, the method includes determining a traffic flux for the block face of interest during the analysis period and estimating a cost rate for the block face of interest during the analysis period as a function of the estimated blocking rate and the determined traffic flux. Furthermore, the method includes recommending at least one price change to a price for parking on the block face of interest in accordance with the blocking rate and the cost rate.

### BRIEF DESCRIPTION OF THE DRAWINGS

FIG. 1 is FIG. 1 is a functional block diagram of a system for recommending parking prices in accordance with one aspect of the exemplary embodiment.

FIG. 2 is a flowchart that illustrates one aspect of the method for recommending prices for parking according to an exemplary embodiment.

FIGS. 3A and 3B are a flowchart that illustrates another aspect of the method for recommending prices for parking according to an exemplary embodiment.

FIG. 4 depicts a plot illustrating the occupancy fraction and fraction-of-time-full in accordance with one aspect of the exemplary embodiment.

FIGS. 5A, 5B, 5C, 5D, 5E, and 5F depict plots illustrating the use of blocking rate in parking prices according to an exemplary embodiment.

FIGS. 6A and 6B depict the occupancy fraction and blocking rate per hour of an example implementation in accordance with aspects of the exemplary embodiment.

### DETAILED DESCRIPTION

One or more implementations of the subject application will now be described with reference to the attached drawings, wherein like reference numerals are used to refer to like elements throughout.

As described herein, there is provided a method for recommending parking prices using blocking rates and traffic flux. The method keeps prices as low as possible without blocking too many people from parking. The method further controls the number of drivers who are denied a space as the street is fully occupied. Accordingly, the systems and methods set forth herein maximize the number of occupied spaces, while limiting the number of people who wanted to park but could not (i.e., blocked drivers) because the street was full, as well as the corresponding congestion caused by the drivers slowing down while looking for spaces.

In the following, the terms “optimization,” “minimization,” “maximizing,” and similar phraseology are to be broadly construed as one of ordinary skill in the art would understand these terms. For example, these terms are not to be construed as being limited to the absolute global optimized value, absolute global minimum, absolute global maximum, and so forth. For example, minimization/maximization of a function may employ an iterative minimization/maximization algorithm that terminates at a stopping criterion before an absolute minimum/minimum is reached. It is also contemplated for the optimized, minimum or maximum value to be a local optimized, local minimum or local maximum value.

It will be appreciated that the subject systems and methods described hereinafter provide evaluations and recommended pricing that offer a pricing mechanism based upon a detailed analysis of the social cost due to an individual being unable to park on the block side where the driver wants to park. The systems and methods set forth herein shift the focus towards the probability of blocking rather than simply the average occupancy fraction as found in current methods. Furthermore, the systems and methods provide for the integration of costs, such as the effect of blocking on surrounding traffic, which depends upon the traffic flux. That is, the subject systems and methods enable the estimation of the different components of the cost from both parking sensor and traffic sensor data. Accordingly, the embodiments set forth in detail below include outputting recommended pricing and evaluations of current prices. While discussed in terms of parking, they are applicable to a variety of other pricing problems.

Accordingly, the embodiments set forth below facilitate the maintenance of as low as possible prices for parking without blocking too many drivers from parking by controlling the number of drivers who are denied a space as the street is fully occupied. In order to accomplish such control, the prices of the spaces are set so as to maximize the number of occupied spaces, while limiting how many people wanted to park but could not because the street was full, as well as the congestion this produced.

### DEFINITIONS

Analysis Period is the period of time during which parking on a block face is being evaluated, e.g., hours during a day, specific day of week, week of month, month of year, etc.

Arrival Rate is the rate at which cars are arriving for parking. The arrival rate may be expressed in number of cars per unit of time, e.g., cars per hour, cars per minute, etc. The arrival rate may be ascertained for a specific analysis period.

Availability is the number of parking spaces open.

Block Face corresponds to the portion of a street that lies between two blocks which is available for parking.

Blocked may be the circumstance wherein a driver is prevented from parking because there was zero availability, the cost for parking was too high, and/or other reasons why the driver could not or would not park.

Blocking Probability is the probability that a block face is full. Fraction-of-time-full is a time average of the blocking probability.

Blocking Rate may include the rate, in vehicles per hour or minutes, at which people arrive who wished to park but could not because availability was zero. The blocking rate may be estimated during a specific analysis period.

Cost Rate is the Blocking Rate times a linear function of the traffic flux; the linear function having an intercept corresponding to the cost to teach person who is blocked and a slope corresponding to the cost to each other person that is slowed down. That is, the slope takes into account the other drivers that are behind the person as that person slows down looking for a space in which to park.

Externality Pricing is the alignment of drivers' incentives with the “good of society.” Used in the absence of reliable estimates for the variation in people's behavior with respect to price.

Fraction-of-time-full is the fraction of time that availability is zero or close to zero.

Occupancy Fraction (Fraction-of-Spaces-Occupied) is the time average of the fraction of spaces that are full.

Parking Space a portion of a block face in which one vehicle may park.

Recommended Price is the new price per hour, and may be close to the cost rate or average cost rate over a specified time interval. That is, the recommended price may correspond to price changes that maximize the difference between the average valuation rate that people get from parking and the cost rate that they cause others.

Traffic Flux may include the number of vehicles passing through the street per hour in the same direction as the person who was blocked.

Utility Rate may represent the difference between the valuation rate and the cost rate, indicated as a price per hour.

Validation Rate may represent the value that people get from being parked in a particular place at a particular time per unit of time, expressed as a price per hour. In the absence of other externalities, the valuation rate would equal the maximum rate that someone would be willing to pay to park in the particular place rather than taking the next best alternative action. The next best alternative action might, for example, be to park on a different street, to use off-street parking, to use public transportation, or the like.

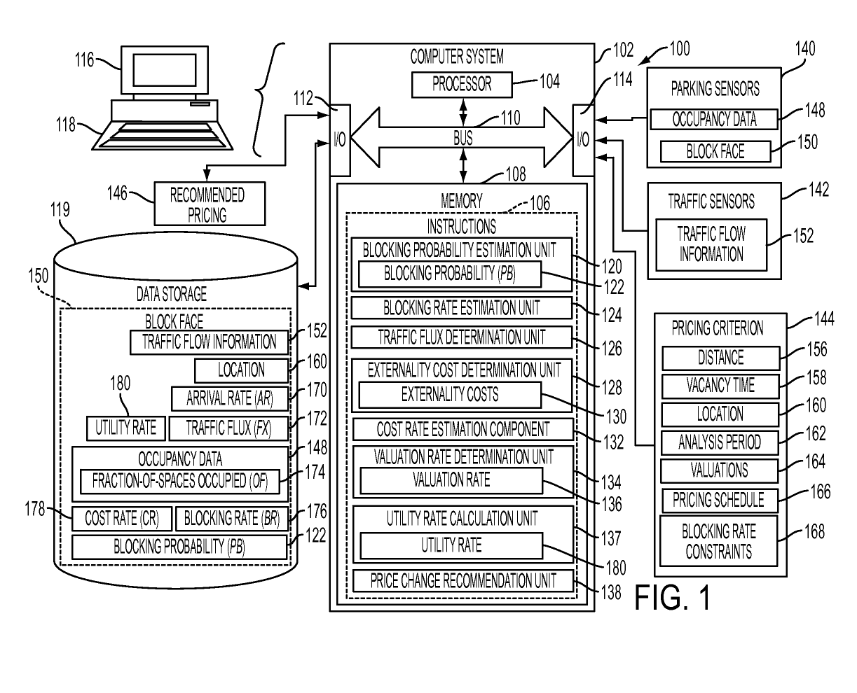

Turning now to FIG. 1, there is shown a functional block diagram of a computer-implemented system 100 for recommending parking prices in accordance with one embodiment of the subject application. It will be appreciated that the various components depicted in FIG. 1 are for purposes of illustrating aspects of the subject application, and that other similar components, implemented via hardware, software, or a combination thereof, are capable of being substituted therein.

The price recommendation system 100 is capable of implementation using a distributed computing environment, such as a computer network, which is representative of any distributed communications system capable of enabling the exchange of data between two or more electronic devices. Such a computer network may include, for example, a virtual local area network, a wide area network, a personal area network, a local area network, the Internet, an intranet, or the any suitable combination thereof. The computer network may include physical layers and transport layers, e.g., Token-Ring, Ethernet, or other wireless or wire-based data communication mechanisms. Furthermore, while depicted in FIG. 1 as a networked set of components, the system and method are capable of implementation on a stand-alone device adapted to perform the methods described herein.

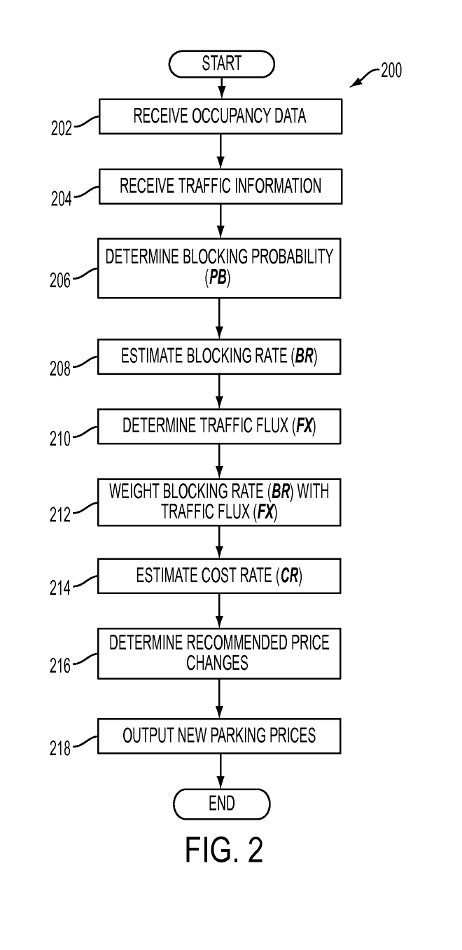

As shown in FIG. 1, the price schedule selection system 100 includes a computer system 102 having a processor 104, which is capable of implementing at least a portion of the exemplary method described in FIG. 2 by execution of software processing instructions 106 which are stored in memory, such as memory 108, which is communicatively coupled to the processor 104. The computer system 102 may include a computer server, workstation, personal computer, combination thereof, or any other computing device. The computer system 102 may further include hardware, software, and/or any suitable combination thereof, configured to interact with an associated user, a networked device, networked storage, remote devices, or the like. The processor 104 may also control the overall operations of the of the computer system 102.

The instructions 106 include a blocking probability estimation unit 120 that estimates a blocking probability (PB) 122 for a block face 150 during a particular analysis period 162. In accordance with one embodiment, the blocking probability (PB) 122 represents the probability that a block face 150 is full ( [symbol] _{[0,1]}). It will be appreciated that a fraction-of-time-full observation of a block face 150 may be represented as a time average of the blocking probability (PB) 122. In accordance with one aspect, the probability estimation unit 120 utilizes the occupancy data 148 from one or more parking sensors 140 over a selected analysis period 162 to estimate the probability (PB) 122 that a driver will be blocked from parking on the block face 150.

According to one aspect, the one or more parking sensors 140 are in communication with the computer system 102 via any suitable means. The parking sensors 140 may be positioned along a block face 150 so as to detect parking spaces that are occupied or unoccupied, as well as the times associated with such detection, i.e., occupancy data 148. It will be appreciated that the parking sensors 140 illustrated in FIG. 1 providing the occupancy data 148 associated with a particular block face 150 may correspond to parking meters, mobile phones, a combination of cameras and inductive-, light-sensitive, capacitance-, sonar- or radar-based sensors. In other embodiments, the parking sensors 140 may be representative of human observations of parking spaces, near-field-communication (NFC) transactions, global positioning system (GPS) navigation device reporting, and the like. The parking sensors 140 may further report to the computer system 102 information relating to the location 160 of a parking space enabling more accurate determinations of not only total occupancy of a block face 150, but also occupancy information relating to specific parking spots on the block face 150. Accordingly, it will be appreciated that the occupancy data 148 for a particular block face 150 may be obtained in myriad ways, and the use of parking sensors 140 herein is intended as an illustrative and not an exhaustive example thereof. Additional calculations relating to the estimation of the blocking probability (PB) 122 by the blocking probability estimation unit 120 are discussed below.

The instructions 106 further include a blocking rate estimation unit 124 that is configured to estimate a blocking rate (BR) 176 corresponding to the rate at which vehicles arrived that wished to park, but could not because a particular block face 150 was full. According to one aspect, the blocking rate (BR) 176 is estimated by the estimation unit 124 over a selected time interval, e.g., a selected analysis period 162. Estimating the blocking rate (BR) 176, according to embodiments contemplated herein, may utilize the occupancy data 148 received from the parking sensors 140, as well as traffic flow information 152 received from one or more traffic sensors 142.

The one or more traffic sensors 142 are configured to report traffic flow information 152 to the computer system 102. The traffic sensors 142 may be implemented on a per block face 150 basis, on a per street basis, on an intersection basis, or combinations thereof. It will be appreciated that the traffic sensors 142 illustrated in FIG. 1 providing traffic flow information 152 from which relating to the arrival rate (AR) 170, the traffic flux (FX) 172, etc., may be implemented as cameras, radar, human observation, induction- or pressure-based sensors, and the like.

The blocking rate (BR) 176 estimated by the blocking rate estimation unit 124 may be ascertained via various processes factoring in the capacity of a block face, the observed occupancy, e.g., the fraction-of-spaces occupied (OF) 174 determined from the occupancy data 148, and the like. Additional example processes are presented below with respect to estimation of the blocking rate (BR) 176.

The following example may be utilized to set forth generally the blocking rate (BR) 176. Assuming the availability of one or two spaces at 4:00 PM on Mondays, then the blocking rate (BR) 176 is zero at that time, whatever the arrival rate (AR) 170. Alternatively, if there is a 50:50 chance that the availability is zero at noon on Fridays, and there are two vehicle arriving every five minutes, then the blocking rate (BR) 176 is: ⅖×50%=0.2 vehicles per minute, or 0.2×60=12 vehicles per hour.

Continuing with the above example, in the event that there is a 50:50 chance that availability is zero at 2:00 AM on Saturdays, and there is one vehicle arriving every two hours, then the blocking rate (BR) 176 is: ½×50%=0.25 vehicles per hour.

A fraction-of-time-full scheme, as previously referenced, would treat noon on Fridays the same as 2:00 AM on Saturdays. However, application of the subject systems and methods acknowledges that the blocking rate (BR) 176 at noon on Fridays is 48 times worse than the 2:00 AM on Saturdays, e.g., 12 vehicles per hour versus 0.25 vehicles per hour.

Returning to FIG. 1, the instructions 106 stored in memory further include a traffic flux determination unit 126 that is configured to receive traffic flow information 152 from the traffic sensors 142 and determine the arrival rate (AR) 170, the traffic flux (FX) 172, and the like, associated with the traffic transiting a particular block face 150 during a selected analysis period 162. According to one aspect, the traffic flux determination unit 126 determines the traffic flow per unit of length of road during the analysis period 162, i.e., the traffic flux (FX) as discussed in detail below.

The instructions 106 also include an externality cost determination unit 128 that is configured to determine the externality costs 130 associated with a vehicle parking or not parking at a space on a block face 150. The externality costs 130 may be determined in accordance with estimated blocking rates (BR) 176, traffic flux (FX) 172, occupancy data 148, various pricing criterion 144, and the like. The externality costs 130 may be costs incurred by drivers other than the one parking, i.e., vehicles that are held up in traffic whilst the driver parallel parks, opens a door to get out, pulls out into traffic, etc. The estimated externality costs 130 may be used in determine a cost rate (CR) 178 for parking, valuation rate 136, and the like, as discussed below. It will be appreciated that other externality costs 130 may be incurred that can be estimated and used in subsequent price recommendations, e.g., costs to restaurants or stores that consistently have no parking available, emergency services due to high volumes of traffic, and the like. According to aspects contemplated herein, the estimation made by the externality cost determination unit 128 may be performed using various available information, e.g., traffic flow information 152, occupancy data 148, pricing criterion 144, survey results, human observations, etc.

The instructions 106 also include a cost rate estimation component 132 that is configured to estimate a cost rate (CR) 178 that involves the blocking rate (BR) 176 times a linear function of the traffic flux (FX) 172. The linear function has an intercept that corresponds to the cost to each person who is blocked and a slope which corresponds to the cost to each other person that is slowed down. Accordingly, the cost rate (CR) 178 is estimated utilizing the blocking rate (BR) 176, the traffic flux (FX) 172, as well as any externality costs 130 related to the block face during the associated analysis period, as discussed in the following example implementation.

The following example may be used to illustrate a simplified cost rate determination. For example, when the blocking rate (BR) 176 is 12 vehicles per hour, it costs $0.50 on average to each person who is blocked, and it costs $0.10 on average to each person who is slowed down, and the traffic flux (FX) 172 through the street is 5 vehicles per minute that is slowed down when a person is blocked. Typically, the costs are generally ascertained via a value of time survey, e.g., hour rates in an area ($15.00-$30.00 in the U.S. dependent upon location). The cost rate (CR) 178 may then be determined as 12×($0.50+(5×$0.10))=$12.00 per hour.

The instructions 106 further include a valuation rate determination unit 134 that is configured to determine a valuation rate 136 associated with parking in a space on the block face 150 at a particular time. The valuation rate 136 corresponds to the value a person ascribes to parking at a particular spot on the block face 150 for a specific amount of time (i.e., an hour, half-hour, two hours, etc.), at a certain day/time. Such a valuation rate 136 may be determined in accordance with received pricing criterion 144, e.g., valuations 164, externality costs 130, or the like. The valuation rate 136 determined by the valuation rate determination unit 134 may be used to recommend price changes. In particular, the valuation rate determination unit 134 may facilitate the determination of the change in the average valuation rate 136 for parking. For example, a person paying two dollars an hour has a valuation rate of at least two dollars an hour. The preceding example may allow for the determination of the valuation rate 136 using subsequent price changes, i.e., when the price is raised to three dollars an hour, the person doesn't park there or stays a shorter amount of time, etc., then the valuation rate determination unit 134 may determine that the valuation rate 136 of a driver who does not park for a price increase from two to three dollars is decreased by fifty cents.

The instructions 106 stored in memory 108 further include a utility rate calculation unit 137 configured to calculate a utility rate 180 in accordance with the computed valuation rate 136 and the cost rate (CR) 178 determined above. In one aspect, the utility rate calculation unit 137 determines the utility rate 180 associated with various changes to the price of a parking space on a block face 150. For example, the utility rate calculation unit 137 may calculate the utility rate 180 for a space or all spaces on a block face 150 for a specific time interval within an analysis period 162 for no price change, a small increase in price, a small decrease in price, a large increase in price, a large decrease in price, etc. An example of varying changes in price is depicted in TABLE 2 discussed below.

The price change recommendation unit 138 is configured to generate recommended pricing 146 for a block face 150, individual spots on the block face 150, or the like, that maximizes the utility rate 180, i.e., the difference between an average valuation rate 136 that a person gets from parking and the cost rate (CR) 178 that the person causes to others in parking. According to one aspect, the price change recommendation unit 138 may generate recommended pricing in accordance with how the blocking rate (BR) 176 and number of people who park (e.g., occupancy data 148) vary with price. In such an aspect, price-elasticities may be assumed for the arrival rate (AR) 170 and occupancy fraction (OF) 174, which might range from −2% per dollar to −80% per dollar, noting that arrival rates (AR) 170 typically vary less than occupancy fractions (OF) 174, since some people might stay longer when the price decreases. Ideally, these assumed elasticities are: estimated from historical data; vary with location, time-of-the-week and the current price; and vary from month-to-month. Furthermore, recommended pricing 146 may be made conservatively with respect to the sensitivity of recommended prices 146 to the assumed elasticities.

It will be appreciated that the price change recommendation unit 138 may determine recommended pricing 146 in accordance with a plurality of pricing criterion 144, e.g., distance 156, vacancy time 158, location 160, analysis period 162 (time of day, day of week, season, etc.), valuations 164, current pricing schedule 166, blocking rate constraints 168, and the like. The pricing criterion 144 may be input by an administrator, manager, or other user of the computer system 102, may represent information or data gained from observation or calculations, and the like. According to one embodiment, the non-limiting listing of pricing criterion 144 may be used to adjust pricing, determine externality costs, determine blocking rates (BR) 176, traffic flux (FX) 172, and the like, as discussed below.

In accordance with varying aspects described herein, several pricing approaches may be utilized. For example and without limitation, recommended pricing 146 may be determined in accordance with externality-based pricing (setting prices in proportion to an estimated cost), target-based pricing (increase prices if a measure exceeds an upper limit and decrease prices if the measure is below a lower limit), model-based pricing (a trade-off between different measures that are optimized and a model of how those measures changes as the price is changed, such that prices are set to optimize that trade-off or to move in the general direction of optimizing that trade-off), or the like. It will be appreciated that the above-identified example approaches may utilize results of a performance metric, e.g., blocking rates (BR) 176, cost rates (CR) 178, traffic flux (FX) 172, etc.

The output of the system 100 may be recommended pricing 146 that corresponds to a price or prices for a space or spaces on a block face 150 that maximizes the number of spaces that are occupied, while limiting how many people wanted to park, but could not, because the street was full, while also accounting for the congestion on the street this produced. According to one aspect, the recommended pricing 146 correspond to changes in a price schedule 166 for the block face that maximizes the difference between the average valuation rate 136 that people get from parking and the cost rate (CR) 178 that they cause to others. The following example illustrates various recommended pricing 146 in accordance with the aspects set forth herein.

For purposes of this example, the current price schedule 166 indicates the price is $2.50 per hour between the hours of noon and 3:00 PM. The occupancy data 148, traffic flow information 152, and cost rate (CR) 178 are presented in the following TABLE 1:

TABLE 1

| | Occupancy | Arrival Rate | Cost Rate |
|---|---|---|---|
| Time | Fraction | (per Hour) | ($ per Hour) |
| 12 noon-12:30 PM | 0.9 | 24 | 11 |
| 12:30 PM-1:00 PM | 0.9 | 4 | 1.8 |
| 1:00 PM-3:00 PM | 0.7 | 4 | 0.5 |
| Average | | 2.5 | |

As illustrated in TABLE 1, when externality pricing is utilized with averaging, the appropriate cost rate (CR) 178 is $2.50, which is equivalent to the currently charged rate. Unfortunately, the vehicles arriving from noon to 12:30 PM will find this very bad as they are often blocked from parking (indicated by the high occupancy fraction (OF) 174, high arrival rate (AR) 170 and corresponding estimated cost rate (CR) 178). Those arriving between 1:00 and 3:00 PM may also experience angst, as they can usually find a parking space, but have to pay $2.50 an hour for it.

Continuing with the above-referenced example, when an alternate pricing is used, e.g., a combination of the above-identified pricing schemes. Accordingly, a comparison is made between a 50-cent and $1.00 increase in price. For the given street and time interval, an assumption is made that a 50 cent price increase reduces occupancy by 8% and arrival rate by 5%, while a $1.00 increase reduces occupancy by 16% and arrival rate by 10%. Thus, the valuation rate per occupied space would decrease by 0.25×8%=$0.02 per hour under a 50 cent increase and by 0.5×16%=$0.08 per hour under a $1.00 increase, which imply the changes illustrated in TABLE 2.

TABLE 2

| | Price Change | | | | | | | | | | | |
|---|---|---|---|---|---|---|---|---|---|---|---|---|
| | 0 | 0.5 | 1 | 0 | 0.5 | 1 | 0 | 0.5 | 1 | 0 | 0.5 | 1 |
| | Occupancy | | | Probability | | | | | | | | |
| Time | Fraction | | | Blocked | | | Arrival Rate | | | Cost Rate | | |
| 12:00-12:30 | 0.90 | 0.83 | 0.76 | 0.46 | 0.29 | 0.18 | 24.0 | 22.8 | 21.6 | 11.0 | 6.61 | 3.82 |
| 12:30-13:00 | 0.90 | 0.83 | 0.76 | 0.46 | 0.29 | 0.18 | 4.00 | 3.80 | 3.60 | 1.84 | 1.10 | 0.64 |
| 13:00-15:00 | 0.70 | 0.64 | 0.59 | 0.12 | 0.08 | 0.05 | 4.00 | 3.80 | 3.60 | 0.48 | 0.30 | 0.18 |
| Average | | | | | | | | | | | | |

| | Price Change | | | | | | | | |
|---|---|---|---|---|---|---|---|---|---|
| | 0 | 0.5 | 1 | 0 | 0.5 | 1 | 0 | 0.5 | 1 |
| | Valuation | | | | | | Revenue | | |
| Time | Rate | | | Utility Rate | | | Rate | | |
| 12:00-12:30 | 9.45 | 8.69 | 7.94 | −1.59 | 2.08 | 4.11 | 2.25 | 2.48 | 2.65 |
| 12:30-13:00 | 9.45 | 8.69 | 7.94 | 7.61 | 7.59 | 7.30 | 2.25 | 2.48 | 2.65 |
| 13:00-15:00 | 7.35 | 6.76 | 6.17 | 6.87 | 6.46 | 5.99 | 1.75 | 1.93 | 2.06 |
| Average | | | | 5.58 | 5.92 | 5.90 | 1.92 | 2.12 | 2.25 |

As shown in TABLE 2, read from left-to-right, the occupancy fraction 174 in each period decreases as the price increases. This leads to a rapid decrease in the probability (blocking probability (PB) 122) that any given arrival is blocked. Subsequently, the arrival rate (AR) 170 decreases with price, but at a lesser rate than the occupancy fraction (OF) 174. The combined effect is a substantial decrease in the cost rate (CR) 178 over the period 12 noon to 12:30 PM: as a price of $2.50 per hour increases to a price of $3.50 per hour, the cost rate (CR) 178 decreases from $11.00 per hour to $3.82 per hour.

The valuation rate 136 for that same period, which is $10.50 times the occupancy fraction (OF) 174, shows a relatively small decrease from $9.45 dollars per space per hour to $7.94 dollars per space per hour. Thus, a utility rate 180 may be obtained corresponding to the difference between the valuation rate 136 and the cost rate (CR) 178. This utility rate 180 would indicate a preference for a $1.00 increase over the period 12 noon to 12:30 PM. However, if this is combined with a decrease in the utility rate 180 for the remainder of the time interval, then the net effect is that a price increase of $0.50 is preferable, as this has an average utility rate 180 over the 12 noon-3 PM time interval of $5.92 per space per hour, which is larger than the utility rate 180 of the other alternative prices explored.

The last columns of TABLE 2 show that the city or parking authority controlling parking pricing would increase their revenue if the price went from $2.50 to $3.50 per hour, but they will not do so, since the aim is to maximize the utility to the citizens.

Returning to FIG. 1, the computer system 102 may also include one or more interface devices 112, 114 for communicating with external devices or to receive external input. The I/O interface 112 may communicate with one or more of a display device 116, for displaying information to users, such as an optimized price schedule 144, and a user input device 118, such as a keyboard or touch or writable screen, for inputting text, and/or a cursor control device, such as mouse, trackball, or the like, for communicating user input information and command selections to the processor 104. The I/O interface 112 may receive output from parking sensors 140, output from traffic sensors 142, and pricing criterion 144, as are discussed in greater detail below. The various components of the computer system 102 may be all connected by a data/control bus 110.

The computer system 102 may be in communication with a data storage device 119 via the I/O interface 112. The data storage 119 is capable of implementation on components of the computer system 102, e.g., stored in local memory 108, i.e., on hard drives, virtual drives, or the like, or on remote memory accessible to the computer system 102.

The associated data storage 119 corresponds to any organized collections of data (e.g., pricing information, occupancy information, traffic information, parking information) used for one or more purposes.

Implementation of the associated data storage 119 is capable of occurring on any mass storage device(s), for example, magnetic storage drives, a hard disk drive, optical storage devices, flash memory devices, or a suitable combination thereof. The associated data storage 119 may be implemented as a component of the computer system 102, e.g., resident in memory 108, or the like.

In one embodiment, the associated data storage 119 may include data corresponding to block faces 150, such as traffic flow information 152, the location 160 of parking spaces on a block face 150, arrival rates (AR) 170, traffic flux (FX) 172, occupancy data 148, including fraction-of-spaces occupied (OF) 174, blocking probabilities (PB) 122, blocking rates (BR) 176, cost rates (CR) 178, and the like. It will be appreciated that additional information about the block face 150 may also be stored on the data storage 119 and used by the computer system 102 in the systems and methods for recommending pricing set forth herein. Accordingly, the listing in the data storage 119 is intended as exemplifying, but not limiting, the data stored thereon.

The memory 108 may represent any type of non-transitory computer readable medium such as random access memory (RAM), read only memory (ROM), magnetic disk or tape, optical disk, flash memory, or holographic memory. In one embodiment, the memory 108 comprises a combination of random access memory and read only memory. In some embodiments, the processor 104 and memory 108 may be combined in a single chip. In another embodiment, the memory 108 may further correspond to any mass storage device(s), for example, magnetic storage drives, a hard disk drive, optical storage devices, flash memory devices, or a suitable combination thereof. The network interface(s) 112, 114 allow the computer to communicate with other devices via a computer network, and may comprise a modulator/demodulator (MODEM). Memory 108 may store data the processed in the method as well as the instructions for performing the exemplary method.

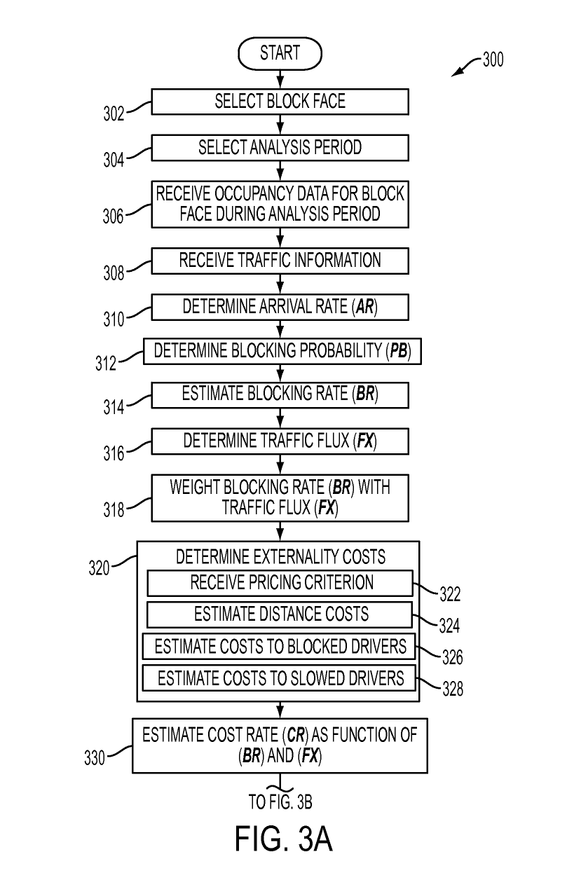

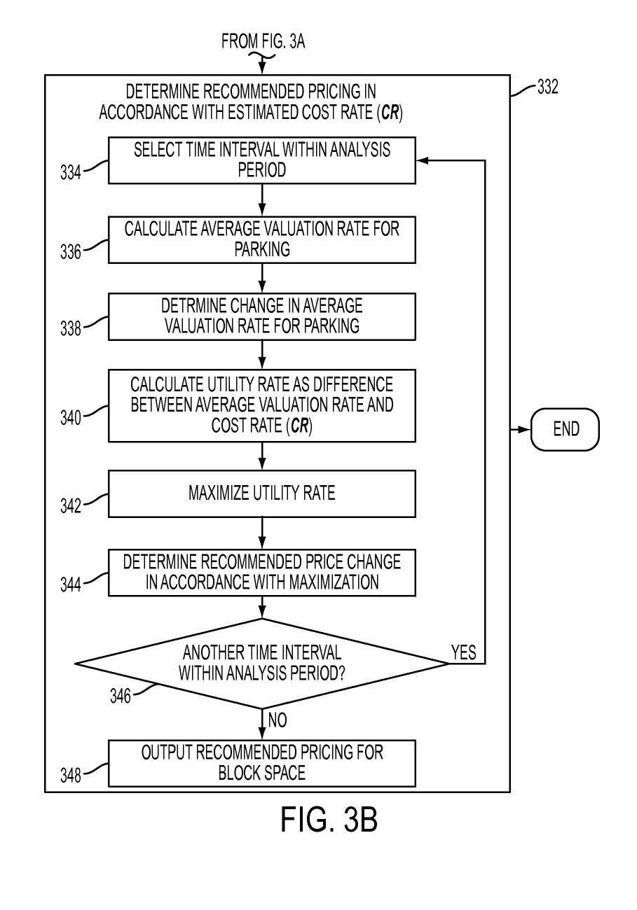

The digital processor 104 can be variously embodied, such as by a single core processor, a dual core processor (or more generally by a multiple core processor), a digital processor and cooperating math coprocessor, a digital controller, or the like. The digital processor 104, in addition to controlling the operation of the computer 102, executes instructions stored in memory 108 for performing the method outlined in FIGS. 2 and 3.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

Turning now to FIG. 2, there is shown a flow chart 200 illustrating an exemplary method for recommending parking prices according to one aspect. The methodology 200 depicted in FIG. 2 begins at 202, whereupon occupancy data 148 is received by the computer system 102 from one or more parking sensors 140. As discussed above, the collection of occupancy data 148 may be performed by various sensors 140 positioned in spaces along a block face 150, via analysis of closed-circuit television cameras, via human observations, via reporting of parking meters, or the like.

Traffic flow information 152 is then received at 204 by the computer system 102 from the one or more traffic sensors 142, as discussed above. It will be appreciated that while reference is made to traffic sensors 142 being utilized to provide the traffic flow information 152, other types of collection components may be used, including, for example, human observations, traffic cameras, various types of pressure sensors, magnetic switches, or the like.

At step 206, the probability that a block face 150 is full, i.e., the blocking probability (PB) 122, is determined by the blocking probability estimation unit 120 or other suitable component associated with the computer system 102. The blocking probability estimation unit 206 may be implemented as an internal hardware component of the computer system 122, e.g., a dedicated microchip, controller, etc. When not implemented as internal hardware of the computer system 102, the blocking probability estimation unit 206 may be implemented as software in memory 108 that acts as instructions 106 that cause the processor 104 to process the received traffic flow information 152 to estimate the blocking probability (PB) 122 in accordance with the exemplary methodology 200 depicted in FIG. 1.

At step 208, the blocking rate (BR) 176, i.e., the rate at which people arrive, who wished to park but could not because availability is zero is estimated in accordance with data received from one or more sensors 142, observer, and the like. In one embodiment, the blocking rate estimation unit 124 is implemented as hardware (e.g., application specific integrated circuit (ASIC), microprocessor, controller, etc.) in communication with the computer system 102, and uses the collected information. It will further be appreciated that the blocking rate estimation unit 124 may be implemented as software alone in memory 108 run by the processor 104 or a combination of software and hardware. A more detailed example of the estimation of the blocking rate (BR) 176 is set forth with respect to FIGS. 3A-3B below.

After estimation of the blocking rate (BR) 176, operations proceed to 210, whereupon the traffic flux (FX) 172 is determined in accordance with processing of the received traffic information 152 by the traffic flux determination unit 126 or other suitable component, instruction, or unit of the computer system 102. As discussed above, the traffic flux (FX) 172 corresponds to the traffic flow per unit of length of road during the analysis period 162, i.e., the number of vehicles traveling in the same direction as a person who is blocked on the block face 150.

The blocking rate (BR) 176 is then weighted in accordance with the traffic flux (FX) 172 at 212. At 214, a cost rate (CR) 178 is estimated in accordance with the blocking rate (BR) 176 and the determined flux weighted blocking rate, as well as any associated externality costs 130, as referenced above. Recommended price changes 146 are then determined at 216 in accordance with the estimated cost rate (CR) 178, pricing criterion 144, occupancy data 148, traffic flow information 152, various externality costs, etc. The recommended pricing 146 is then output by the computer system 102 for implementation on the block face 150 for a selected analysis period 162.

Referring now to FIGS. 3A-3B, there is shown a flowchart 300 depicting another aspect of the method for recommending prices for parking according to an exemplary embodiment. Operations with respect to FIGS. 3A-3B may best be described via usage of the following time series: the fraction of spaces occupied, i.e., the occupancy fraction (OF) 174 that may be represented as ( [symbol] _{[0,1}]); the blocking probability (PB) 122, which is the probability that a block face 150 is full ( [symbol] _{[0,1}]) (fraction-of-time-full is a time average of the blocking probability (PB) 122); the arrival rate (AR) 170 that corresponds to the rate of arriving vehicles who wish to park per hour ( [symbol] ₊hr⁻¹); the blocking rate (BR) 176, which corresponds to the rate at which vehicles wished to park, but could not, because a block face was full ( [symbol] ₊hr⁻¹); the traffic flux (FX) 172, which is the traffic flow per unit length of road ( [symbol] ₊hr⁻¹); the flux-weighted blocking rate blocking probability (FXBR), which is the traffic flux times the blocking rate ( [symbol] ₊hr⁻¹); and the cost rate (CR) 178, which is a linear combination of the blocking rate (BR) 176 and the flux-weighted blocking rate (FXBR). The methodology of FIGS. 3A-3B begins at 302, whereupon a particular block face 150 is selected for analysis. At 304, an analysis period 162 is selected corresponding to the interval during which data, e.g., occupancy data 148, traffic information 152, pricing criterion 144, etc., is to be collected or retrieved from the data storage device 119 for analysis.

At 306, the occupancy data 148 for the selected block face 150 during the selected analysis period 162 is received, i.e., from the parking sensors 140 positioned on the block face 150, from the data storage 119, or the like. At 308, traffic information 152 is received corresponding to traffic on the block face 150 during the analysis period 162. It will be appreciated that such traffic information 152 may be received by the computer system 102 via one or more traffic sensors 142 positioned on the block face 150, from previously acquired data stored on the data storage device 119, or the like.

At 310, the arrival rate (AR) 170 is determined from the traffic information 152 corresponding to the number of vehicles traversing the block face 150 during the selected analysis period 162. For example, the arrival rate (AR) 170 may correspond to the rate at which vehicles arrive at the block face 150 traveling in the same direction as parking is allowed. The blocking probability (PB) 122 is then determined at 312 via the blocking probably estimation unit 120 or other suitable component, instruction, unit, etc., of the computer system 102. As discussed below, estimation of the blocking probability (PB) 122 may be made from the fraction of spaces occupied (OF) 174 using the truncated Poisson law.

At 314, the blocking rate (BR) 176 is estimated in accordance with determined arrival rate (AR) 170, the occupancy data 148, the blocking probability (PB) 122, etc. In accordance with aspects of the subject disclosure, the subject systems and methods may utilize various methodologies in estimating the blocking rate (BR) 176. The estimation of the blocking rate (BR) 176 may be undertaken via the aforementioned time series. More specifically, a stochastic process z(t) may be utilized which counts the occupancy at time on a block face 150 of capacity C. This process jumps up or down by one as driven by an arrival process A(t) and a departure process D(t) so that:

dz=1_{z(t)≠C}dA−dD;

where the indicator function in the first term prevents arrivals given zero availability. The arrivals are then given by dz⁺ (the positive part of dz) and the blocked arrivals are given by (1_{z(t)=C}dA) which counts arrivals when availability is zero. The blocking rate (BR) 176 over time interval T, whose length is also denoted by T, and the flux-weighted blocking rate (FXBR) are then:

$$BR := \frac{1}{T} {\int }_{T} {1}_{z ( t ) = C} d A , FXBR := \frac{1}{T} {\int }_{T} FX ( t ) {1}_{z ( t ) = C} d A ( t ) .$$

In accordance with one embodiment, the average of these rates, taken over several repeated observations, is used to estimate a corresponding cost rate. It will be appreciated, however, that averaging these time series may present complications. For example, observations may be censored, either because something unusual occurred, such as sensor failures, road closures, or because it is only possible to observe arrivals when a block face 150 is not at capacity. Secondly, direct estimates of the blocking probability (PB) 122, which comprise counting the fraction of observations of a given time at which a block face 150 is full, are usually more variable than is useful. For example, during an analysis period of four weeks, only 4 observations of the block face 150 for a given time of the week are available, such that the blocking probability (PB) 122 values from the set {0, ¼, ½, ¾, 1} were collected. Yet, a block face 150 which was at seen at occupancy (C−1) four times, where C is the capacity of the block face 150, is clearly more likely to be blocked in future than one which was seen at occupancy 0 four times (assuming that C≧2).

Estimation of the blocking probability (PB) 122 may be made from the fraction of spaces occupied (OF) 174 using the truncated Poisson law. Specifically, given capacity C and Poisson rate x, the following equations may be solved:

$$OF = \frac{{xγ}_{R} ( x , C )}{C {γ}_{R} ( x , C + 1 )} , PB = \frac{{e}^{- x} {x}^{C}}{C ! {γ}_{R} ( x , C + 1 )} ;$$

where the upper tail of the regularized incomplete gamma function is:

$${γ}_{R} ( x , C ) := \frac{1}{Γ ( c )} {\int }_{X}^{∞} {e}^{- t} {t}^{C - 1} d t .$$

In accordance with one embodiment, these equations may be solved using one or more lookup tables.

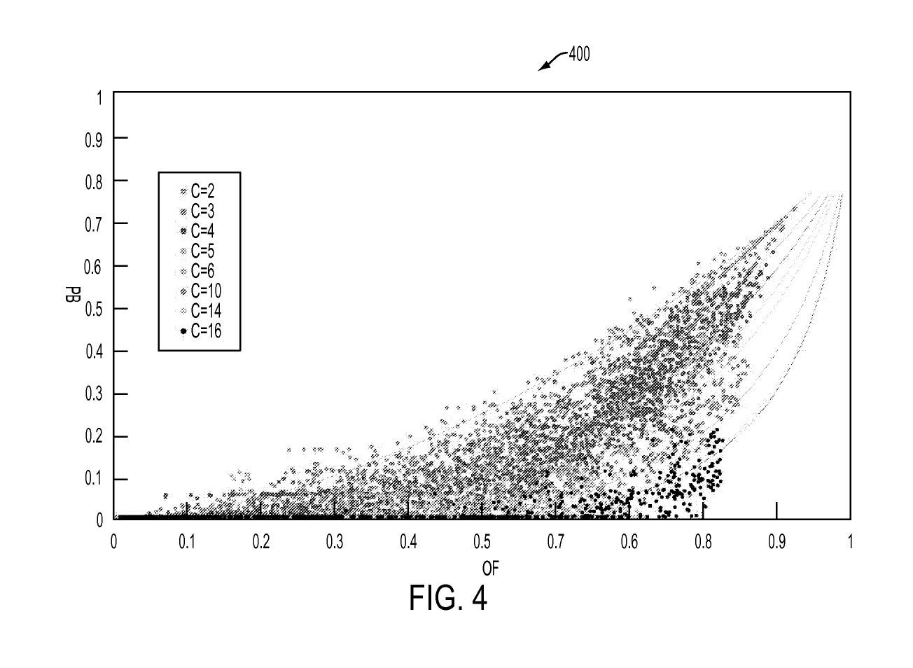

FIG. 4 presents a plot 400 justifying the preceding approximation. The plot 400 presented in FIG. 4 illustrates the occupancy fraction and fraction-of-time-full as estimated directly from all 15 minute intervals of the week, over 19 weeks of data for 12 block faces 150. The curves depicted in FIG. 4 show the relevant truncated Poisson law for capacity C.

Given that the blocking probability (PB) 122 may be estimated from the occupancy fraction (OF) 174 which takes on a discrete range of values for any finite data set, the blocking rate may be written in terms of the level-sets of occupancy fraction (OF) 174 over a time interval T whose length is also denoted by T as:

$$BR := \frac{1}{T} {\int }_{T} PB ( OF ( t ) ) λ ( t ) d t = \frac{1}{T} {\sum }_{f ∈ range ( OF )} {\int }_{{T}_{f}}^{ } λ ( t ) d t ;$$

where λ(t) is the arrival rate (AR) 170 at time t, range (X) is the set of values that X takes and,

T_{f}:={tεT:OF(t)=f};

is the subset of the time interval over which the occupancy fraction equals f. For example, when A(Z,N) arrivals in total unblocked time U(Z,N) are observed, i.e., the total time over which arrivals might have been observed since the data was not censored and the availability was not zero, for the time interval:

T(Z,N):={tεT:Z(t)=Z,N(t)=N};

where N(t) is the number of uncensored observations of time t and Z(t) is the total occupancy at that time (i.e., the sum over all repeated trials—such as weeks—of the occupancy observed at that time, provided that occupancy was not censored). The average blocking rate (BR) 176 over interval T is then estimated as:

$$BR = \frac{1}{T} {\sum }_{Z , N} PB ( \frac{Z}{N} ) ( \frac{A ( Z , N )}{U ( Z , N )} ) T ( Z , N ) .$$

Returning to FIGS. 3A-3B, after estimation of the blocking rate (BR) 176, operations proceed to 316, whereupon the traffic flux (FX) 172 is determined in accordance with the received traffic flow information 152. The blocking rate (BR) 176 is then weighted with the determined traffic flux (FX) 172 at 318 so as to calculate the flux-weighted blocking rate (FXBR). For example, Given the traffic flux FX(t) 172, each arrival that was counted in A(Z,N) is weighted, but the traffic flux (FX) 172 at that time to construct a flux weighted arrival count A_{FX}(Z,N), and then obtain the flux-weighted blocking rate (FXBR) is presented as:

$$FXBR = \frac{1}{T} {\sum }_{Z , N} PB ( \frac{Z}{N} ) ( \frac{{A}_{FX} ( Z , N )}{U ( Z , N )} ) T ( Z , N ) .$$

At 320, the externality costs 130 are determined by the externality cost determination unit 128 or other suitable component, unit, instruction, associated with the computer system 102. The determination of the externality costs 130 performed at 320 may comprise one or more costs, as illustrated in FIGS. 3A-3B, such as receiving 322 and using various pricing criterion 144, e.g., vacancy time 158, location 160, valuations 164, pricing schedules 166, blocking rate constraints 168, etc. The determination at 320 may further include estimating distance costs 324 corresponding to the distance 156 from a desired space a driver was forced to park, the distance 156 from a desired place of business the driver was forced to park, the amount of time taken by a driver to walk from a parking space to his/her destination, etc. In accordance with one aspect, the arrival rate (AR) 170 may be used to identify a location, the distance 156 to the nearest vacancy may then be determined, thereby providing the distance 156 from where a driver wanted to park to the space where the driver was able to find a space to park. In the foregoing aspect, the location could be determined based upon observations of spaces that are least likely to be unoccupied or that remain unoccupied for the shortest amount of time, thus identifying the space as a desirable space. Thereafter, estimating the cost based on the distance 156 may be made via weighting of this distance 156 using the arrival rate (AR) 170.

In addition, the determination of externality costs 130 at 320 may also include estimating costs to blocked drivers 326 and estimating costs to slowed drivers 328. The costs to blocked drivers 326 may include the aforementioned distance costs from 324, the inconvenience of driving to a different location, fuel costs, time delays, etc. The costs to slowed drivers 328 may include time delays, fuel costs, annoyance costs, etc., to those drivers arriving on the block face 150 and trapped behind the blocked driver as the blocked driver slows to locate a space, waits for a space to open, parallel parks, etc. As will be appreciated, the estimation of costs at 326 and 328 may be derived in accordance with surveys of drivers, human observations, past available data, inferences from occupancy data 148 or traffic flow information 152, or the like. For example, parking in a space which is surrounded by full spaces causes extra externality when the traffic flux in 15 minutes (VOL) is large: 8 seconds for stopping to assess the space; 3 seconds for mirror checking/adjusting, signaling, shifting into reverse; 11 seconds to reverse into the space (22 seconds total elapsed time) versus simply indicating, slowing down and driving in, which is approximately 2 seconds of delay (negligible cost). The externality costs 130 determined in accordance with the systems and methods set forth herein, however, may scale this additional 20 seconds with VOL and include costs to businesses that value arrivals.

At 330, a cost rate (CR) 178 is estimated in accordance with the blocking rate (BR) 176 and the flux-weighted blocking rate (FXBR), as well as the determined externality costs 130, particularly the estimated costs to blocked drivers at 326 and the estimated costs to slowed drivers at 328. That is, to obtain a cost-rate (CR) 178, an intercept c₀ and slope c₁ are specified to obtain a cost rate (CR) 178 of:

CR=c₀BR+c₁FXBR;

Wherein the intercept c₀ corresponds to the externality costs 130 attributed to each person who is blocked from parking and wherein the slope c₁ corresponds to externality costs 130 attributed to each person that is slowed down.

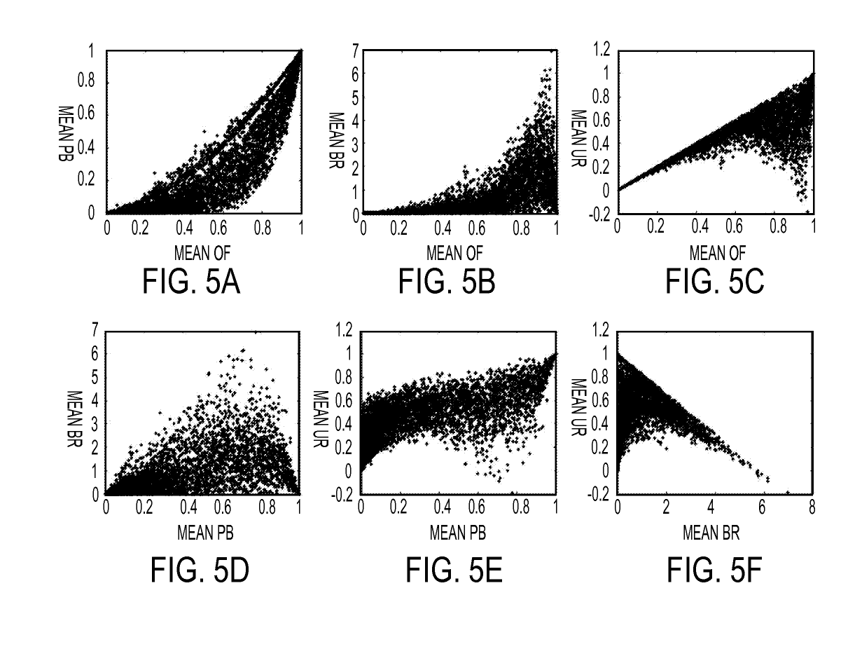

FIGS. 5A, 5B, 5C, 5D, 5E and 5F illustrate an example implementation demonstrating that blocking rate (BR) 176 can lead to rather different conclusions than the use of OF 174 or PB 122. In FIGS. 5A-5F, UR is the following proxy for a normalized utility rate 180 per space:

UR:=OF−PB/6;

Where the fraction-of-spaces occupied, i.e., the occupancy fraction (OF) 174 is a number in [0,1] and the blocking rate (BR) 176 is measured in hr⁻¹. The data used in constructing FIGS. 5A-5F was obtained over all 15 minute intervals of the week from block faces 150 in Los Angeles, each averaged over 8 weeks of data. (In this example, the blocking probability (PB) 122 was computed under the truncated Poisson assumption, corresponding to the curves shown in the FIGS. 5A-5F). Notably, it is possible to have OF=0.5 yet BR=2, and OF=0.9 yet BR=0.5.

It will be appreciated that the foregoing formulae depend upon the blocking probability (PB) 122. However, the blocking probability (PB) 122 may also be estimated directly by counting the fraction of repeated observations over which the street, i.e., the block face, was fully occupied, or indirectly by adding a small Poisson random variable to the observed occupancies. The blocking probability (PB) 122 may also be estimated while taking into account the uncertainty in the occupancy fraction, e.g., integrating over a negative binomial predictive distribution, or by Monte Carlo via the addition of a small non-Poisson stochastic process to the observed occupancies, for instance an integer auto-regressive (“INAR”) process.

It will further be appreciated that the preceding formulae may further depend upon the arrival rate (AR) 170, which may be estimated by averaging over time windows, via kernel density estimation, via fitting a non-Poisson stochastic process such as an INAR process, or the like. For example, the estimates referenced above may be constructed by assuming priors, e.g., the blocking probability may be assumed to be a beta random variable, the arrival rate may include a gamma prior. Furthermore, posterior distributions or confidence intervals for such statistics may be constructed. Such construction becomes particularly important, i.e., when the statistics vary considerably from month-to-month or other such analysis period 162. For example, Monte Carlo simulations may present such variance. In addition, the arrival rate may be roughly viewed as a beta random variable, and the blocking probability (PB) 122 is roughly viewed as a beta random variable. Therefore, the blocking rate (BR) 176 may be roughly viewed as a beta-gamma random variable. It will be appreciated that beta-gamma random variables are frequently well-approximated by gamma random variables. This approximation can be accomplished by moment matching, e.g., one might match the mean and either the variance or the mean logarithm of the beta-gamma random variable, to those of a gamma random variable.

As shown in FIGS. 3A-3B, recommended pricing 146 is determined in accordance with the estimated cost rate (CR) 178 at 332. In accordance with one example embodiment, determining the recommended pricing 146 at 332 may be 146 accomplished by adjusting the price per hour closer to the cost rate or to the average cost rate over a specified time interval, albeit usually with some rounding to the nearest 50 cents or 1 dollar. This use of the aforementioned externality pricing is directed to aligning the drivers' incentives with the “good of society.” In the absence of reliable estimates for the variation in drivers' behavior with respect to price, this simple approach is sensible. Thus, at 332, the 146 determination may include, for example, averaging the cost rate (CR) 178 over a time interval of the analysis period 162, e.g., averaging the cost rate (CR) 178 over the hours of 12:00 PM to 3:00 PM. Operations with respect to FIGS. 3A-3B terminate thereafter with an output of the recommended pricing 146 for the block face 150 during the analysis period 162.

FIGS. 3A-3B illustrate one example methodology for determining recommended pricing 146 in accordance with the estimated cost rate (CR) 178. For example, it will be appreciated that averaging the cost rate (CR) 178 over such a time interval does not guarantee the “good of society” in situations where the cost rate (CR) 178 is high for some portion of the time interval and low for one or more other portions of the time interval. That is, people under-pay in the portion where the cost rate is high and over-pay in the portion where the cost rate is low. Accordingly, in such circumstances, as illustrated in FIGS. 3A-3B, operations proceed within 332 to 334.

At 334, a time interval within the selected analysis period 162 is selected or otherwise designated for purposes of analysis. For example, when the analysis period 162 corresponds to a set amount of time, e.g., the hours of 7:00 AM to 1:00 PM, a time interval therein may comprise a subset thereof, e.g., 15, 30, or 60 minute intervals, or the like. Operations then proceed to 336, whereupon 146 the average valuation rate is calculated for drivers during the time interval in accordance with the valuation rates 136 determined for the drivers via the valuation rate determination unit 136. As discussed above, the valuation rate 136 for a driver may be determined via value of time surveys, observations, etc. In one aspect, the valuation rates per occupied space for the parking interval are averaged to determine the average valuation rate 136 via the valuation rate determination unit 134 or other suitable component, device, or module associated with the computer system 102.

The change in the average valuation rate 136 for parking during the time interval with respect to a price change is then determined at 338. For example, it may be inferred that a person paying $2.00 per hour has a valuation rate of at least $2.00 per hour and that if they do something else when the price is changed to $3.00 per hour (e.g., park elsewhere, stay a shorter period of time, come less frequently, etc.), then while the exact valuation rate 136 for the person is unknown, it may be determined that the person had something else to do that was worth somewhere between $2.00 and $3.00 per hour (something more valuable to the person). Thus, an assumption may be made that the valuation rate of a person who goes away for a price increase of $2.00 to $3.00 is decreased by $0.50, i.e., the change in the average valuation rate 136 determined at 338.

At 340, the utility rate 180 is calculated as the difference between the average valuation rate 136 and the cost rate (CR) 178 for each average valuation rate 136 and cost rate (CR) 178 with respect to the change in average valuation rate at 338 relative to price changes during the time interval. TABLE 2, described above, illustrates the utility rate 180 calculated for different portions of a time interval within the analysis period 162, e.g., 12:00-12:30, 12:30-13:00, 13:00-15:00. At 342, the utility rate 180 is maximized a recommended price 146 change is then determined at 344 in accordance with an outcome of the maximization. Operations then proceed to 346, whereupon a determination is made whether another time interval remains for examination within the analysis period 162. Upon a positive determination at 346, operations return to 334 as discussed above. Upon a negative determination at 346, operations proceed to 348, whereupon the recommended pricing 146 for parking during the analysis period 162 is output. It will be appreciated that the recommended pricing 146 may include changes in rates in accordance with different time intervals, rates for particular spaces in accordance with distance (as discussed at 328 above), and the like.

### EXAMPLES

According to one aspect, the direct observation of people or vehicles being blocked may not be easily obtained, thus requiring the use of modeling assumptions. For example, it may be that a street always gets full, but no-one gets blocked because exactly the same drivers arrive every week in roughly the same temporal sequence. It would be “unfair” to charge such carefully-coordinated drivers for blocking. If this were the case, then the number of arrivals per week would not be very variable, relative to the variability expected from a Poisson distribution. TABLE 3 illustrates the number of arrivals in the week of Jul. 4, 2011 and 12 following weeks, for 12 block faces in LA. (These were selected as the largest set of faces for which we have a full 12 weeks of data and for which we are not aware of any anomalous behavior. Only arrivals which were followed by a stay of at least 1 minute are included in this data, as shorter “arrivals” may correspond to drive-in-drive-out sequences from the parking of a single vehicle or spurious sensor readings from passing vehicles.)

TABLE 3

| Block Face | Capacity | 04-Jul | 11-Jul | 18-Jul | 25-Jul | 01-Aug | 08-Aug | 15-Aug | 22-Aug |
|---|---|---|---|---|---|---|---|---|---|
| 200 E. 5TH ST | 2 | 199 | 219 | 180 | 168 | 198 | 195 | 218 | 199 |
| 700 E. 12TH ST | 3 | 153 | 137 | 173 | 158 | 139 | 117 | 156 | 148 |
| 200 W. 5TH ST | 5 | 415 | 448 | 448 | 431 | 423 | 470 | 444 | 412 |
| 101 W. 3RD ST | 4 | 256 | 252 | 256 | 307 | 273 | 249 | 273 | 287 |
| 301 SPRING ST | 3 | 676 | 781 | 675 | 741 | 617 | 765 | 619 | 698 |
| 100 W. 5TH ST | 10 | 912 | 1085 | 1013 | 1003 | 872 | 971 | 922 | 882 |
| 701 12TH ST | 14 | 1476 | 1708 | 1702 | 1701 | 1545 | 1699 | 1693 | 1724 |
| 201 W. 5TH ST | 3 | 323 | 453 | 506 | 568 | 411 | 426 | 369 | 380 |
| 701 N. | 4 | 518 | 551 | 558 | 565 | 527 | 560 | 429 | 373 |
| BROADWAY | | | | | | | | | |
| 200 SPRING ST | 15 | 1200 | 1322 | 1332 | 1576 | 1328 | 1308 | 961 | 1345 |
| 401 SPRING ST | 4 | 367 | 451 | 347 | 117 | 324 | 424 | 337 | 365 |
| 401 ALPINE ST | 6 | 838 | 782 | 702 | 633 | 669 | 693 | 545 | 519 |
| TOTAL | | 7333 | 8189 | 7892 | 7968 | 7326 | 7877 | 6966 | 7332 |

| | | | | | | | | Fano |
|---|---|---|---|---|---|---|---|---|
| Block Face | 29-Aug | 05-Sep | 12-Sep | 19-Sep | 26-Sep | Mean | Variance | Factor |
| 200 E. 5TH ST | 206 | 185 | 223 | 192 | 164 | 196 | 339 | 1.7 |
| 700 E. 12TH ST | 150 | 117 | 146 | 131 | 169 | 146 | 301 | 2.1 |
| 200 W. 5TH ST | 415 | 447 | 548 | 401 | 375 | 437 | 1730 | 4.0 |
| 101 W. 3RD ST | 326 | 297 | 268 | 367 | 286 | 284 | 1140 | 4.0 |
| 301 SPRING ST | 775 | 638 | 680 | 707 | 711 | 699 | 3095 | 4.4 |
| 100 W. 5TH ST | 943 | 1116 | 984 | 799 | 888 | 953 | 7805 | 8.2 |
| 701 12TH ST | 1918 | 1558 | 1872 | 1629 | 1784 | 1693 | 15302 | 9.0 |
| 201 W. 5TH ST | 469 | 468 | 537 | 463 | 448 | 448 | 4593 | 10.3 |
| 701 N. | 356 | 354 | 388 | 332 | 418 | 456 | 8373 | 18.4 |
| BROADWAY | | | | | | | | |
| 200 SPRING ST | 1245 | 1070 | 1293 | 1147 | 1148 | 1252 | 23160 | 18.5 |
| 401 SPRING ST | 373 | 342 | 216 | 402 | 418 | 345 | 8072 | 23.4 |
| 401 ALPINE ST | 441 | 474 | 510 | 384 | 370 | 582 | 22387 | 38.5 |
| TOTAL | 7617 | 7066 | 7665 | 6954 | 7179 | 7490 | 165841 | 22.1 |

As illustrated in TABLE 3, the Fano factor (the ratio of the variance of the number of arrivals per week to its mean) is larger than one in all cases, where one is the value expected of a Poisson distribution. Thus, it will be appreciated that it does not appear that drivers are carefully coordinating their arrivals in this data set.

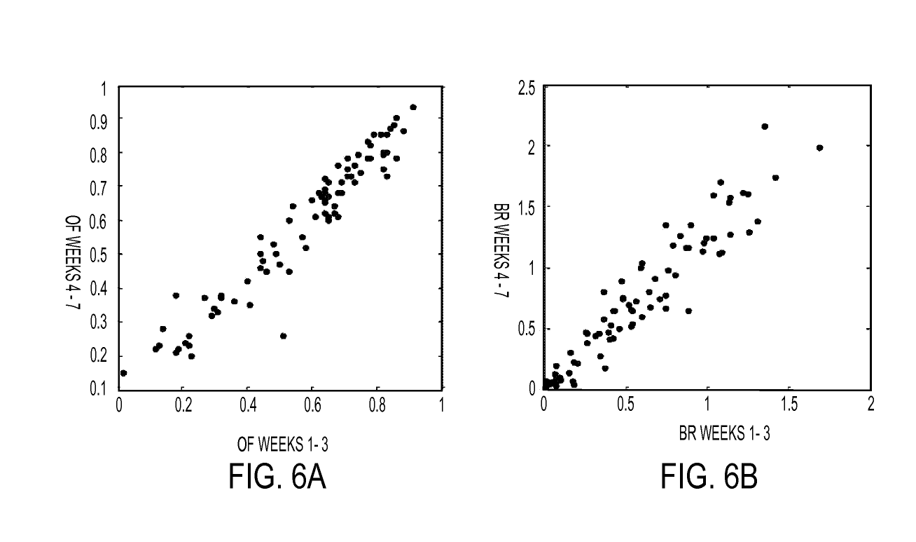

In addition, the results set forth in TABLE 3 raise another concern, i.e., whether pricing based on blocking rate may lead to large oscillations from one price change to the next—as indicated by the variability in the arrival rate from week to week. To assess this risk, 87 block faces in LA for 7 weeks were observed, and an evaluation of the occupancy fraction and blocking rate for the first 3 week period and for the next 4 week period was made. It will be understood that the time frame selected was arbitrary in nature, based upon varying embodiments wherein price changes are made in a particular city approximately every two months, whereas a shorter change period may be used in other cities. FIGS. 6A and 6B depict the occupancy fraction (OF) 174 per hour (FIG. 6A) and blocking rate (BR) 176 per hour (FIG. 6B), averaged over currently-priced hours of the week, for each face for the two periods.

It is not immediately apparent that blocking rate (BR) 176 is much more variable than the occupancy fraction (OF) 174. The correlation coefficient of the occupancy fraction (OF) 174 from period to period is 0.963 and that of blocking rate (BR) 176 from period to period is 0.955. TABLE 4 depicts price changes on the occupancy fraction (OF) 174 thresholds at 0.4, 0.6 and 0.8 and on blocking rate (BR) 176 at 0.5, 1 and 1.5. Accordingly, TABLE 4 illustrates the count of how many block faces 150 lied in each of the four regions implied by these thresholds over the two periods.

TABLE 4

| OF | weeks 4-7 | | | | BR | weeks 4-7 | | | |
|---|---|---|---|---|---|---|---|---|---|
| weeks 1-3 | 19 | 1 | 0 | 0 | weeks 1-3 | 36 | 8 | 0 | 0 |
| | 2 | 14 | 2 | 0 | | 0 | 17 | 11 | 0 |
| | 0 | 1 | 32 | 3 | | 0 | 0 | 6 | 8 |
| | 0 | 0 | 6 | 7 | | 0 | 0 | 0 | 1 |

As will be appreciated, the ranges selected do not correspond to a substantially “coarser” quantization of blocking rate (BR) 176 than of the occupancy fraction (OF) 174, since the totals of the columns range from 10 to 40 for the occupancy fraction (OF) 174 and from 9 to 36 for blocking rate (BR) 176. In both cases, the of blocking rate (BR) 176 and OF values are band diagonal, which indicates that changes made one month would not get immediately reversed the next month. The off-diagonal sum is 15 for OF and 27 for blocking rate (BR) 176 which suggests that blocking rate (BR) 176 could be considered more variable for the given thresholds, but this could also be interpreted by saying that “the real externality costs” vary from month-to-month.

The method illustrated in FIGS. 2-3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowcharts 200 and 300 shown respectively in FIG. 2 and FIGS. 3A-3B, can be used to implement the exemplary price schedule optimization method.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for recommending prices for parking, comprising:
receiving data representative of parking occupancy for an associated block face during an analysis period;
receiving data representative of traffic flow for the associated block face during the analysis period;
estimating a blocking rate for the analysis period in accordance with the received parking occupancy data and the traffic flow data; and
determining a recommended price for parking on the associated block face during the analysis period in accordance with the estimated blocking rate and traffic flow data,
wherein at least one of the receiving, receiving, estimating, or determining is performed by a processor in communication with associated memory.

2. The method for recommending prices of claim 1, further comprising:
determining a blocking probability that a driver will be blocked from parking on the associated block face during the analysis period in accordance with the received occupancy data; and
estimating the blocking rate in accordance with the determined blocking probability.

3. The method for recommending prices of claim 1, further comprising determining a traffic flux for the associated block face in accordance with the received traffic flow data.

4. The method for recommending prices of claim 3, further comprising estimating a cost rate as a function of the estimated blocking rate and the determined traffic flux, wherein the recommended price is determined in accordance with the estimated cost rate.

5. The method for recommending prices of claim 4, further comprising determining at least one externality cost corresponding to parking on the associated block face, wherein estimating the cost rate further includes the at least one externality cost.

6. The method for recommending prices of claim 5, wherein the at least one externality cost corresponds to at least one of an estimated cost to a blocked driver or an estimated cost to a slowed driver.

7. The method for recommending prices of claim 6, wherein the estimated cost to a blocked driver includes a cost associated with a distance from a nearest vacancy to an occupied space on the associated block face.

8. The method for recommending prices of claim 6, wherein the function of the blocking rate and the traffic flux includes an intercept corresponding to the estimated cost to a blocked driver and a slope corresponding to the estimated cost to a slowed driver.

9. The method for recommending prices of claim 5, further comprising:
determining a valuation rate for each occupied space on the associated block face during a portion of a time interval of the analysis period; and
calculating an average valuation rate for parking during the portion of the time interval on the associated block face via the determined valuation rates.

10. The method for recommending prices of claim 9, further comprising:
calculating a utility rate for each portion of the time interval of the analysis period, the utility rate corresponding to a difference between the average valuation rate and the cost rate for the portion of the time interval,
wherein determining a recommended price further comprises maximizing the utility rate for the portion of the time interval.

11. The method for recommending prices of claim 10, further comprising:
for each of a plurality of price changes during each portion of the time interval, calculating a respective utility rate associated therewith;
averaging utility rates for a price change across each portion of the time interval; and
recommending the price change corresponding to a highest average utility rate.

12. A computer program product comprising a non-transitory recording medium storing instructions, which when executed on a computer causes the computer to perform the method of claim 1.

13. A system comprising memory storing instructions for performing the method of claim 1, and a processor in communication with the memory which implements the instructions.

14. A system for recommending prices for parking, comprising:
a processor;
a blocking rate estimation unit configured for computing a blocking rate in accordance with occupancy data and traffic flow information corresponding to an associated block face during an analysis period;
a traffic flux determination unit configured for computing a traffic flux for the block face during the analysis period;
an externality cost determination unit configured for computing at least one externality cost associated with parking on the associated block face;
a cost rate estimation unit configured for computing a cost rate for the block face during the analysis period in accordance with the blocking rate, the traffic flux, and the at least one externality cost;
memory in communication with the processor, which stores instructions which are executed by the processor for:
determining a valuation rate for each occupied space on the associated block face during a portion of a time interval of the analysis period,
calculating an average valuation rate for parking during the portion of the time interval on the associated block face via the determined valuation rates,
calculating a utility rate for each portion of the time interval of the analysis period, the utility rate corresponding to a difference between the average valuation rate and the cost rate for the portion of the time interval, and
maximizing the utility rate for the portion of the time interval to determine a recommended price corresponding thereto.

15. The system for recommending prices of claim 14, further comprising instructions for:
calculating a respective utility rate for each of a plurality of price changes during each portion of the time interval; and
averaging utility rates for a price change across each portion of the time interval,
wherein the recommended price corresponds to a highest average utility rate.

16. The system for recommending prices of claim 15, wherein the at least one externality cost associated with parking on the associated block face corresponds to at least one of an estimated cost to a blocked driver or an estimated cost to a slowed driver.

17. The system for recommending prices of claim 16, wherein the estimated cost to a blocked driver includes a cost associated with a distance from a nearest vacancy to an occupied space on the associated block face.

18. The system for recommending prices of claim 14, further comprising a blocking probability estimation unit configure for computing a blocking probability that a driver will be blocked from parking on the associated block face during the analysis period in accordance with the received occupancy data, wherein the blocking rate is estimated in accordance with the blocking probability.

19. A computer-implemented method for recommending prices for parking, comprising:
receiving occupancy data corresponding to a block face of interest;
receiving traffic flow information associated with the block face of interest;
estimating a blocking rate for the block face of interest in accordance with the occupancy data and the traffic flow information during an analysis period;
determining a traffic flux for the block face of interest during the analysis period;
estimating a cost rate for the block face of interest during the analysis period as a function of the estimated blocking rate and the determined traffic flux; and
recommending at least one price change to a price for parking on the block face of interest in accordance with the blocking rate and the cost rate.

20. The computer-implemented method for recommending prices for parking of claim 19, further comprising:
determining a valuation rate for each occupied space on the block face of interest during a portion of a time interval of the analysis period;
calculating an average valuation rate for parking during the portion of the time interval on the associated block face via the determined valuation rates;
calculating a utility rate for each portion of the time interval, the utility rate corresponding to a difference between the average valuation rate and the cost rate for the portion of the time interval; and
recommending the price change in accordance with a maximization of the utility rate for the portion of the time interval.
